(19) United States
(12) Patent Application Publication
(10) Pub. No.: US 2005/0108751 A1
(43) Pub. Date: May 19, 2005

(54) TV remote control with display

(75) Inventor: Behram Mario Dacosta, San Diego, CA (US)

Correspondence Address: ROGITZ & ASSOCIATES;Suite 3120, 750 B Street, San Diego, CA, 92101, US

(73) Assignees: SONY CORPORATION, Tokyo (JP); SONY ELECTRONICS INC., Park Ridge, NJ (US)

(21) Appl. No.: 10/778,526

(22) Filed: Feb. 16, 2004

Related U.S. Application Data
(60) Provisional application No. 60/520,763, filed on Nov. 17, 2003.

(51) Int. Cl. H04N 7/173; H04N 5/445; H04N 5/44; G06F 13/00; G06F 3/00

(52) U.S. Cl. 725/39; 348/734; 725/51; 725/119

(57) ABSTRACT

A remote control device for a TV has a display on which an electronic program guide (EPG) received from the TV can be displayed, so that the TV itself does not have to superimpose the EPG on the video being shown on the TV screen. Also, video of programs being previewed using the remote control device EPG can be sent from the TV to the remote control device for display. A TV GUI can be sent to the remote as well from the TV or from a PVR associated with the TV.

### RELATED APPLICATIONS

This application claims priority from U.S. provisional patent application Ser. No. 60/520,763, filed Nov. 17, 2003.

### FIELD OF THE INVENTION

The present invention relates generally to television remote control devices.

### BACKGROUND

The current restrictions on TV remote controls, along with controls for other audio-visual devices, present unnecessary impediments to the television operator's watching pleasure. These obstacles to comfortable viewing often decrease user adoption and sales of devices including or requiring a remote control. One of the central barriers to the desired comfort level involves the placement of the Electronic Program Guide (EPG). In all current television devices, the EPG is displayed on the television screen along with the program being currently viewed. This presents a number of problems to the operator. The text of the EPG is often not clear and legible enough to be read from various points of view. Further, additional information on an entry on the EPG, such as the description of a movie, cannot easily be requested or viewed. This additional information may not always be accessed from the EPG service and may require access to arbitrary third party resources, such as the internet.

The current placement of the display for the EPG is directly on the television screen, usually leaving a small corner of the television for which the current program can be viewed. This obstructs the view of the operator, who may desire to watch the current program while also searching for other programs on the EPG. Also, previewing of other channels displayed on the EPG cannot transpire without affecting the currently viewed channel. Yet another hindrance to current devices' viewing capabilities is the fixed user-interface for televisions, which may not be appropriate for control of arbitrary devices connected to the televisions. An example of this is an arbitrary third party personal video recorder. Another setback to present viewing systems is that the status of the television or of a device attached to the television is not always apparent from looking at the television or remote.

### SUMMARY OF THE INVENTION

A system includes a television and a remote control device in wireless communication with the television. The remote control device includes a visual display, and the visual display presents at least two of: a video stream received from the TV, a graphical user interface (GUI) including controls for operating the TV, and an electronic program guide (EPG).

Preferably, the remote control device presents both the video stream and the EPG, with the video stream being related to a channel currently selected on the EPG of the remote. The EPG may be received from the TV, from a device attached to the TV, or from the Internet. The GUI, in contrast, may be received (for example) from a personal video recorder (PVR) associated with the TV or from the TV itself. Preferably, the display is a touch screen display, so that the GUI on the display of the remote control device can be used to operate the TV.

In another aspect, a method for controlling a TV includes sending information to a remote control such that the remote control device can generate a GUI for controlling the TV. The method also includes sending information to the remote control such that the remote control device can display an EPG representing channels on the TV, with the remote control device permitting the user to select a channel on the EPG. Also, the method contemplates sending information to the remote control such that the remote control device can display a video stream related to a selected channel on the EPG.

In yet another aspect, a system includes a TV and a remote control configured for wireless communication with the TV and presenting an EPG. Means are provided for sending, from the TV or associated PVR (or other device) to the remote control, a GUI for controlling the TV. Also, means permit a user to select a channel on the EPG, and means present on the remote control a video stream related to a selected channel on the EPG.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present TV system;

FIG. 2 is a schematic diagram of one preferred remote control screen display; and

FIG. 3 is a flow chart of the present logic.

### DETAILED DESCRIPTION OF THE PREFERRED EMBODIMENT

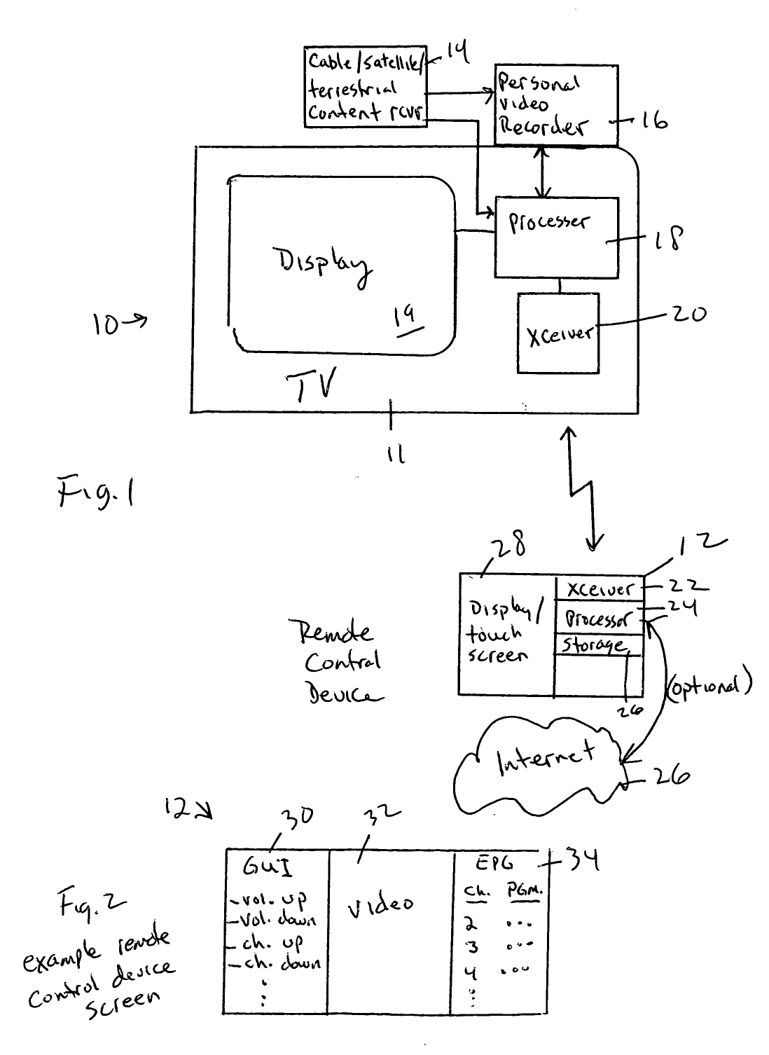

Referring initially to FIG. 1, a system is shown, generally designated 10, that includes a television 11 and a remote control device 12. The television 11 receives a signal from a cable/satellite/terrestrial content receiver 14, or from the Internet (e.g., IP TV). Choice of the program provider is up to the discretion of the operator. The content receiver 14 then transmits signals to a personal video recorder (PVR) 16 and/or directly to a processor 18 within the television 11. The personal video recorder 16 is an optional element added at the operator's will in order to observe images other than those from the content receiver 14.

As shown in FIG. 1, the processor 18 drives a TV display 19 and also sends signals to and receives signals from a wireless Infrared (IR) transceiver 20. In turn, the IR transceiver 20 relays the signal to a complementary wireless transceiver 22 on the remote control device 12. The wireless transceiver 22 could be an optical transceiver (e.g., IR) or an rf transceiver (e.g., IEEE 802.11). The transceiver 22 sends the information to a processor 24 on the remote control device 12. Another option the operator has is to import an internet signal from an external source 26 into the processor 24. The Internet signal may be obtained by the remote control device 12 via a direct connection to the Internet, instead of through the TV. The remote control device 12 also has a storage area 26 to hold information sent by the television 11. The remote control device 12 also contains a visual display/touch screen 28 for purposes to be shortly disclosed.

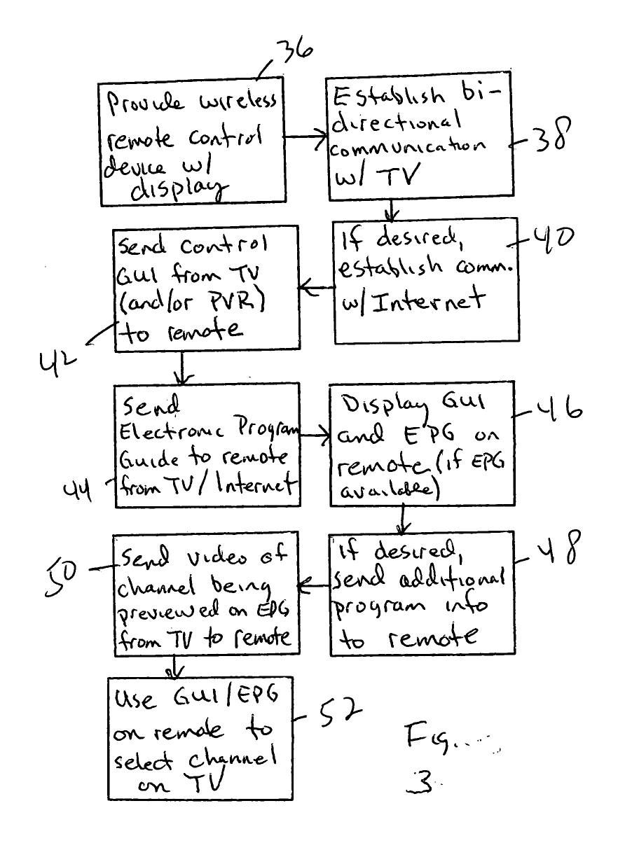

Now referring to FIG. 2, an example of a remote control device screen is shown. A touch-screen graphical user interface (GUI) 30 is shown as being part of the video/touch screen display 28 of the remote control device 12. The GUI 30 may have any number and arrangement of command buttons on it available for the operator to manipulate the television. It is to be understood that the data to drive the GUI is received from the TV or associated PVR, and when a user manipulates the GUI, a control signal is sent to the TV indicating the desired action, e.g., “volume up”, “channel down”, etc. It is to be understood that other modalities or methods of entering information into the remote control device 12, other than buttons, can be supported.

Also, a video area 32 may be part of the visual display 28 of the remote control device 12. The video area 32 presents a video stream of, e.g., a TV show, as transmitted from the television 11 to the remote control device 12.

The preferred visual display 28 may also contain an electronic program guide (EPG) 34, which shows the preferred programs available for observation through the content receiver of the television or through the internet via the processor on the remote control device itself. The EPG 34 can list any number of elements to aid the viewer in search of a desired program, such as channel and program information. It is to be understood that, like the data for generating the GUI 30 and video display area 32, the EPG 34 can be received from the TV 11 over the wireless link, or it can be obtained from the Internet.

FIG. 3 shows the process by which the operator receives all necessary information, including the EPG and GUI. The first block 36 shows the step of providing a wireless remote control device with a display. Proceeding to block 38, bi-directional communication with the television must be established. Then, at block 40, communication with the internet can be established, if desired.

Moving to block 42, the preferred television (and/or the PVR 16) sends the control GUI to the remote control device 12. The process then shifts to the next block 44 in which the television sends the EPG to the remote control device. Alternatively, the EPG could be sent from the Internet 26.

Moving to block 46, the GUI and EPG (should it be available) are displayed on the remote control device. In block 48, the television can send additional program information to the remote control device. Moving to block 50, the television sends a video stream of the channel being previewed on the EPG from the television to the remote control device. To this end, the user may select a channel for preview on the EPG by, e.g., touching the area of the display over the desired channel, it being understood that the video stream presented on the remote device 12 is from the channel selected for preview on the EPG. If the user touches the selection twice, the channel on the TV itself can be changed to the selected channel. At block 50 the user utilizes the GUI and EPG on the remote control device to select whichever channel he/she desires to view on the television.

While the particular TV REMOTE CONTROL WITH DISPLAY as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

1. A system, comprising:
at least one television system; and
at least one remote control device in wireless communication with the television system, the remote control device including at least one visual display, the visual display presenting at least two of: a video stream received from the TV system, a graphical user interface (GUI) including controls for operating the TV system, and an electronic program guide (EPG).

2. The system of claim 1, wherein the remote control device presents both the video stream and the EPG, the video stream being related to a channel currently selected on the EPG of the remote.

3. The system of claim 2, wherein the EPG is received from the TV system.

4. The system of claim 2, wherein the remote control device communicates with the Internet, and the EPG is received from the Internet.

5. The system of claim 2, wherein the GUI is received from at least one of: the TV system, and a personal video recorder (PVR) associated with the TV.

6. The system of claim 1, wherein the display is a touch screen display.

7. The system of claim 1, wherein the GUI on the display of the remote control device is used to operate the TV system.

8. A method for controlling a TV, comprising:
sending information to a remote control such that the remote control can display a GUI for controlling the TV;
sending information to the remote control such that the remote control can display an EPG representing channels on the TV, the remote control permitting the user to select a channel on the EPG; and
sending information to the remote control such that the remote control can display a video stream related to a selected channel on the EPG.

9. The method of claim 8, wherein the selected channel is indicated by touching a touch screen display of the remote control.

10. The method of claim 8, wherein the EPG is received from the TV.

11. The method of claim 8, wherein the EPG is received from the Internet.

12. The method of claim 8, wherein the GUI is manipulated using a touch screen display on the remote control to control at least a volume and channel on the TV.

13. A system, comprising:
a TV;
a remote control configured for wireless communication with the TV and presenting an EPG;
means for sending to the remote control, from at least one of: the TV, and a personal video recorder associated therewith, a GUI for controlling the TV;
means for permitting a user to select a channel on the EPG; and
means for presenting on the remote control a video stream related to a selected channel on the EPG.

14. The system of claim 13, wherein the selected channel is indicated by touching a touch screen display of the remote control.

15. The system of claim 13, wherein the EPG is received from the TV.

16. The system of claim 13, wherein the EPG is received from the Internet.

17. The system of claim 13, wherein the GUI is manipulated using a touch screen display on the remote control to control at least a volume and channel on the TV.
